(19) United States
(12) Patent Application Publication
(10) Pub. No.: US 2012/0253694 A1
(43) Pub. Date: Oct. 4, 2012

(54) METHOD AND APPARATUS FOR JUDGING STATUS OF MECHANICAL SYSTEM

(76) Inventors: Hong-Tsu Young, Taipei (TW); Yu-Hsiang Pan, Yilan City (TW); Yung-Hung Wang, Taipei City (TW); Wei-Yen Lin, New Taipei City (TW)

(21) Appl. No.: 13/229,883

(22) Filed: Sep. 12, 2011

(30) Foreign Application Priority Data
Mar. 28, 2011 (TW) 100110588

(51) Int. Cl. G01N 29/14; G06F 19/00

(52) U.S. Cl. 702/34

(57) ABSTRACT

A method for judging the status of a mechanical system is provided. First, a vibration signal related to the mechanical system is provided. Subsequently, an empirical mode decomposition process is performed on the vibration signal, so as to generate a plurality of intrinsic mode functions. Plural target intrinsic mode functions are selected from the intrinsic mode functions. Based on the target intrinsic mode functions, the status of the mechanical system is judged.

### BACKGROUND OF THE INVENTION

1. Field of the Invention

The present invention relates to methods and apparatuses for ascertaining damages. In particular, the present invention relates to methods and apparatuses for detecting and identifying damages in mechanical systems.

2. Description of the Prior Art

Generally, there are two purposes of inspecting a mechanical system for damages. The first purpose is to find out the damaged component and the cause of damage. Corresponding solutions can then be performed. Second, recognizing the omen of damage and taking a precaution before a component is actually damaged can prolong the work life of a mechanical system. Taking a tool machine as an example, after long-term rotation, some components therein might start to wear and the processing performance is decreased. Other components relative to the worn part may also be damaged. To raise the quality of products, reduce manufacture cost, and shorten time of repair, regular or continuous inspection for damages is necessary for a mechanical system.

A mechanical system under operation generally vibrates. A non-destructive inspection can be performed by monitoring the vibration signal. More specifically, by comparing the vibration signals respectively in a normal machine and a damaged machine, the vibration characteristic when damage exists can be recognized. However, at the present time, most tool machine and shaft-related industries lack the ability to perform signal processing and correctly analyze the vibration signal.

The commonest analysis of a vibration signal is calculating the root mean square of vibration amounts. This analysis is quick and simple, but can only detect whether damage exists. With only root mean square values, the type of damage cannot be identified. Taking the shaft in a tool machine as an example, problems might happen in the shaft include assembly defect, overheat, over-grease, etc. If the cause of damage is not known, the maintenance man has to check all the possibilities. Besides, the vibration characteristic in the primary damage stage is unobvious; the analysis above is not able to detect damages in the primary stage.

Fourier transform has also been utilized for vibration analysis. In this method, the vibration signal is decomposed into infinite sine/cosine functions and the natural frequency and spectrum of the vibration signal is generated based on the infinite series. The vibration characteristic is judged according to the frequency and spectrum. Fourier transform is only suitable for linear and stationary signals. However, practical vibration signals of a mechanical system are usually nonlinear and nonstationary. Further, the frequency and spectrum is irrelevant to time. Hence, the analysis results of Fourier transform probably is not able to reflect the real behavior of a mechanical system.

Rotational machines are generally combinations of gear wheels and transmission mechanisms. Signals with several different frequencies are generated during the operation of a rotational machine. At the present time, most vibration analyses are not good enough. Few vibration analyses capable of providing better results a re built on abstruse theories and the results can only be interpreted by professional experts.

### SUMMARY OF THE INVENTION

To solve the aforementioned problems, the invention provides new methods and apparatuses for judging the status of a mechanical system. In methods and systems according to this invention, intrinsic mode functions (IMFs) generated through an empirical mode decomposition (EMD) process are used as the basis of judgment. EMD is a direct analysis that takes local time scales of data variations as energy and is capable of decomposing the original signal into plural IMFs. Because the EMD process can also be applied to nonlinear or nonstationary signals, the vibration signal of a mechanical system is better analyzed. In other words, analysis results capable of revealing the authentic status of the mechanical system are obtained.

One embodiment according to the invention is a method for judging the status of a mechanical system. In this method, a vibration signal related to the mechanical system is first acquired. An EMD process is performed on the vibration signal and plural IMFs are generated. Subsequently, plural target IMFs are selected from the IMFs. Based on the target IMFs, whether a damage condition exists in the mechanical system is judged.

Another embodiment according to the invention is an apparatus for judging the status of a mechanical system. The apparatus includes a collecting module, an EMD module, and a judging module. The collecting module is used for acquiring a vibration signal related to the mechanical system. In the EMD module, an EMD process is performed on the vibration signal, so as to generate plural IMFs. The EMD module also selects plural target IMFs from the IMFs. The judging module is used for judging whether a damage condition exists in the mechanical system based on the target IMFs.

The methods and apparatuses according to this invention can be completely automatized; experts for interpreting the analysis results are not needed. In addition, the methods and apparatuses according to this invention can judge the level and type of damages. Accordingly, the maintenance man of the mechanical system can timely replace or repair the damaged component before the mechanical system is seriously damaged. With the methods and systems according to this invention, cost can be saved, product yield can be raised, and the work life of mechanical systems can be prolonged.

The advantage and spirit of the invention may be understood by the following recitations together with the appended drawings.

### BRIEF DESCRIPTION OF THE APPENDED DRAWINGS

FIG. 1 illustrates the flowchart of the method for judging the status of a mechanical system in one embodiment according to the invention.

FIG. 2 illustrates a detailed example of the judging step in one embodiment according to the invention.

FIG. 3(A) shows an exemplary list of the features of the IMFs generated after an EMD process. FIG. 3(B) is the order-energy plot corresponding to the table in FIG. 3(A). FIG. 3(C)˜FIG. 3(E) illustrate the exemplary order-energy plots of damaged systems.

FIG. 4 illustrates another detailed example of the judging step in one embodiment according to the invention.

FIG. 5(A)˜FIG. 5(C) show the flat-top, one peak, and two peaks conditions that might appear in the marginal spectrum.

FIG. 6˜FIG. 8 illustrate examples that further include step for evaluating the result of the EMD process.

FIG. 9(A)˜FIG. 9(C) illustrate the block diagram of the apparatus for judging the status of a mechanical system in one embodiment according to the invention.

### DETAILED DESCRIPTION OF THE INVENTION

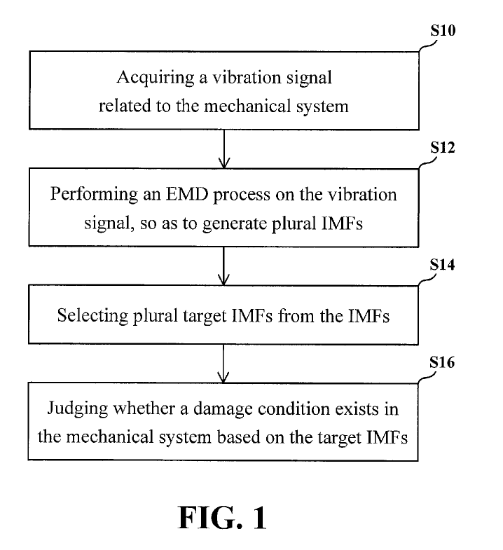

Please refer to FIG. 1, which illustrates the flowchart of the method for judging the status of a mechanical system in one embodiment according to the invention. First, step S10 is executed to acquire a vibration signal related to the mechanical system. For example, one or more vibration detectors (e.g. piezoelectric accelerometers) can be mounted magnetically on the bearings of the shaft of a tool machine under test for collecting the vibration signal of the shaft.

Subsequently, in step S12, an empirical mode decomposition (EMD) process is performed on the vibration signal. EMD is a direct analysis that takes the local time scale of data variations as energy and is capable of decomposing the original signal into plural intrinsic mode functions (IMFs). More specifically, an EMD process can include the following steps:

(1) identifying local maxima in the vibration signal x(t) and connecting all the local maxima by a cubic spline line as the upper envelope;

(2) identifying local minima in x(t) and connecting all the local minima by a cubic spline line as the lower envelope, wherein the upper and lower envelopes cover all the data between them;

(3) designating the mean value of upper and low envelope as m₁ and the difference between x(t) and m₁ as the first component h₁;

(4) judging whether the first component h₁ satisfies the definition of an IMF (described later);

(5) if h₁ is an IMF, the difference between h₁ and x(t) is taken as a new x(t);

(6) if h₁ is not an IMF, h₁ is taken as a new x(t); and

(7) the above steps (1)˜(6) are repeated until the original vibration signal x(t) is decomposed into plural IMFs and a remaining monotonic function.

An IMF satisfies the following conditions: (1) the number of extrema and the number of zero-crossings must either equal or differ at most by one; (2) at any point, the mean value of the envelope defined by local maxima and the envelope defined by the local minima is zero; and (3) there is only one extreme between successive zero-crossings.

In a mechanical system, the vibration of a point might change in both amplitude and speed all the time, but the vibration signal certainly is an up/down symmetric signal that complies with the definition of an IMF. In step S12, plural IMFs are generated based on the vibration signal; each of the IMFs is corresponding to a vibration mechanism or plural vibration mechanisms with similar waveforms and frequency ranges.

In embodiments according to the invention, intermittency criterions or ensemble EMD (EEMD) can be applied, so as to diminish mode mixing conditions induced by noises in the vibration signal. Most noises are irregular intermittency signals. With a mode mixing condition, a single IMF includes two or more different time scales; the definition of time scale herein is the time difference between successive extreme values. If a mode mixing condition exists in an IMF, false variations might be induced in the IMF and the following analysis will be affected. In practice, intermittency criterions or an EEMD can be applied in the aforementioned EMD process if a mode mixing condition occurs. After mode mixing conditions are diminished, frequency losses of the main vibration mode can also be prevented. Frequency loss is a phenomenon might be induced in the EMD process and may cause a discontinuous spectrum and a following misjudgment. The detail of intermittency criterions can be found in “A confidence limit for the empirical mode decomposition and Hilbert spectral analysis” proposed by N. E. Huang, M. C. Wu, S. R. Long, S. S. Shen, W. Qu, P. Gloersen, and K. L. Fan in Proc. R. Soc. London Ser. A459:2317-2345, 2003. The detail of performing an EEMD can be found in “Ensemble empirical mode decomposition: A noise-assisted data analysis method” proposed by Z. Wu and N. E. Huang in Advances in Adaptive Data Analysis, Vol. 1, No. 1, pp. 1-41, 2009.

Step S14 is selecting plural target IMFs from the IMFs generated in step S12. For example, step S14 can include a sub-step of calculating the zero-crossing rate for each of the IMFs. Subsequently, the IMFs with zero-crossing rates corresponding to a target frequency band can be selected as the target IMFs. In practice, if the method according to the invention is performed on a shaft of the mechanical system, the number of target IMFs is generally larger than four.

For example, the zero-crossing rate Zr, of an ith IMF can be calculated according to the equation:

$${Zr}_{i} = \frac{{N}_{i} \times S}{n \times 2} ,$$

wherein N, represents the number of zero-crossing points of the ith IMF, S represents the sampling rate, and n represents the signal length. Taking a rotary machine with a operating speed of 400 Hz as an example, only signals with frequencies higher than 200 Hz (i.e. 0.5 times of the operating speed) have physical significance. Besides, for accelerometers at the present time, the IMFs with zero-crossing rates higher than 5000 Hz are in the response-distortion range of the accelerometers. Therefore, for rotary machines, the aforementioned target frequency band can be designed as, but not limited to, 200 Hz˜5000 Hz. In other words, the IMFs with zero-crossing rates falling in the range 200 Hz˜5000 Hz can be selected as the target IMFs, and the other IMFs generated in step S12 are ignored.

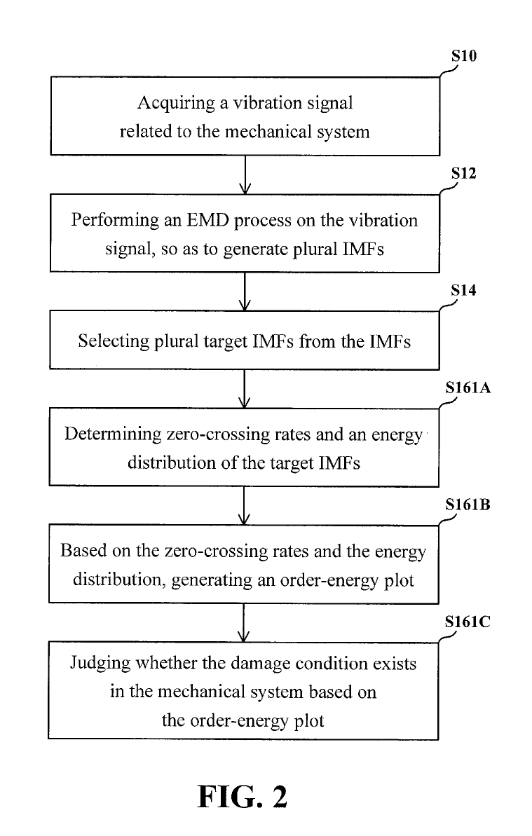

Then, step S16 is judging whether a damage condition exists in the mechanical system based on the target IMFs. FIG. 2 illustrates a detailed example of step S16. In this example, step S16 includes three sub-steps. First, step S161A is determining the zero-crossing rates and an energy distribution of the target IMFs. If the zero-crossing rates of the target IMFs have been found in step S14, step S161A can be simplified as only determining the energy distribution of the target IMFs. The average energy E, of the ith target IMF can be calculated according to the equation below:

$${E}_{i} = \frac{1}{n} {\sum }_{k = 1}^{n} {( {C}_{i} [ k ] )}^{2} ,$$

wherein n represents the signal length, and Cᵢ[k] stands for the kth data value of the ith target IMF.

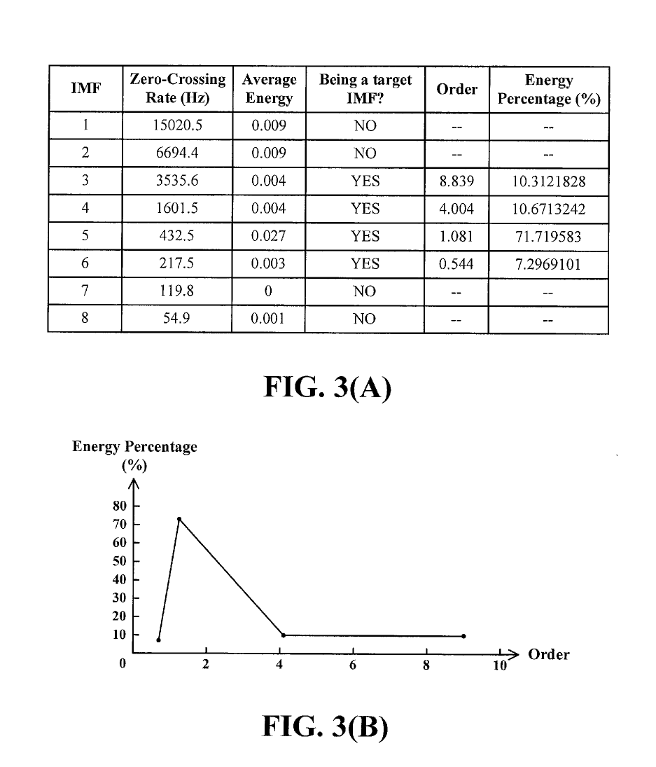

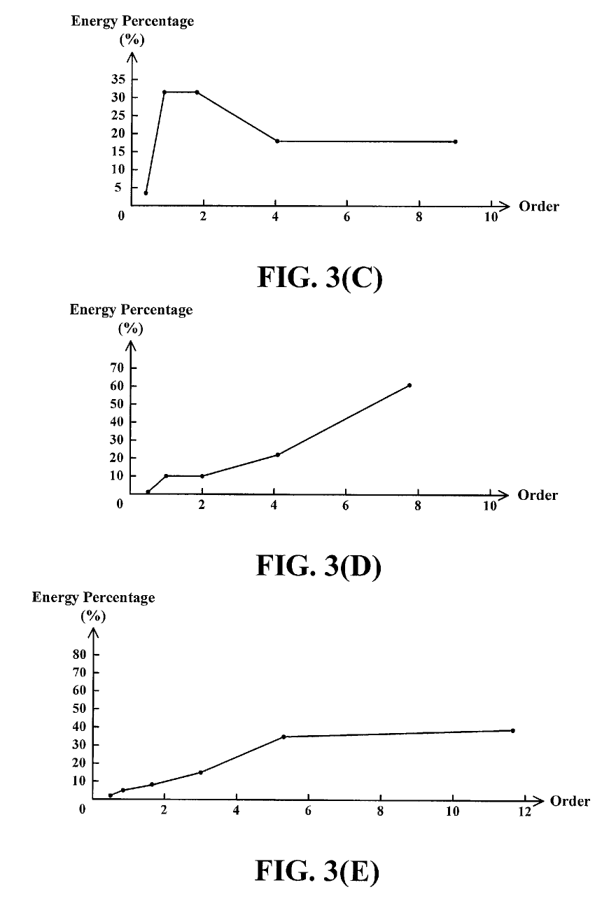

Step S161B is generating an order-energy plot based on the zero-crossing rates and the energy distribution. In the order-energy plot, the horizontal axis is order (i.e. dividing the zero-crossing rate by the operating speed), and the vertical axis is energy percentage (%). This order-energy plot can be a characteristic of the vibration signal. FIG. 3(A) shows an exemplary list of the features of the IMFs generated after an EMD process. In this example, eight IMFs are generated based on the vibration signal, wherein the third, fourth, fifth, and sixth IMFs are selected as the target IMFs. The order and energy percentage of the target IMFs are also shown in the table. FIG. 3(B) is the order-energy plot corresponding to the table in FIG. 3(A). The four points in FIG. 3(B) are corresponding to the four target IMFs, respectively.

Thereafter, step S161C is judging whether a damage condition exists in the mechanical system based on the order-energy plot. As described above, each of the IMFs is corresponding to a vibration mechanism. If a mechanical system is damaged, its vibration mechanisms will become more complicated and the number of IMFs generated after the EMD process will be different from that of a normal system. In addition, the energy distribution of the IMFs will also be changed. In other words, once a damage condition exists in the mechanical system under test, the order-energy plot generated in step S161B is different from an order-energy plot generated in an undamaged system.

Taking a tool machine as an example, problems might happen in the mechanical structure can be classified into the following classes: bearing damage, spindle defect, assembly defect, and less-grease (also an omen for bearing damage). Experiments based on the method according to the invention are performed on a shaft. The experimental results reveal that the vibration signal of a normal shaft is corresponding to four target IMFs and its order-energy plot is similar to the one shown in FIG. 3(B). On the contrary, if the mechanical system under test has one or more assembly defects (e.g. misalignment, less/over-grease, or less/over-preload), its vibration signal is corresponding to five target IMFs. Further, if the shaft has bearing damages, six target IMFs will be generated after the EMD process. FIG. 3(C) illustrates an exemplary order-energy plot of the misalignment condition. FIG. 3(D) illustrates an exemplary order-energy plot of the less-preload condition. FIG. 3(E) illustrates an exemplary order-energy plot of the bearing damage condition.

Based on the statements above, it can be seen that order-energy plots can be used as basis for judging whether a damage condition exists in the mechanical system. Besides directly observing the form of the curve in the order-energy plot, the similarity between two plots can also be considered. More specifically, the similarity between the order-energy plot of a mechanical system under test and a reference order-energy plot can be judged. The reference order-energy plot is related to a normal or damage condition. If the order-energy plot of the mechanical system under test is similar to the reference order-energy plot, whether a damage condition exists in the mechanical system can be judged.

Taking the plot in FIG. 3(B) as an example, the four points in the curve are corresponding to four coordinates; three vectors can be accordingly determined and be viewed as the feature vectors of the vibration signal. For example, by calculating the sum of the included angles of feature vectors, the similarity of two vibration signals can be quantized. The vibration signal of different damage conditions can be previously measured, analyzed, and used for building reference models. The reference models can be stored in a database for future comparisons.

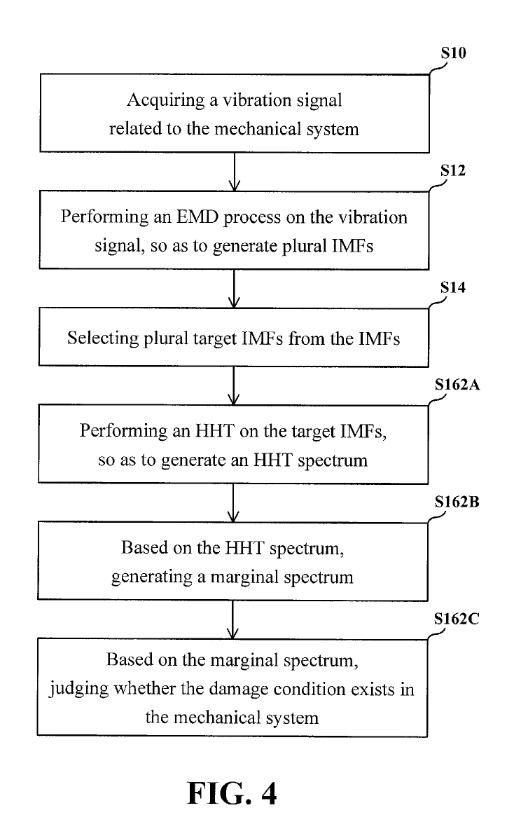

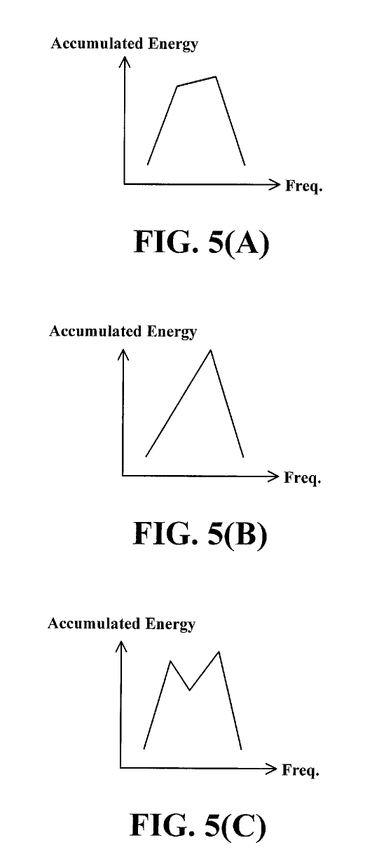

FIG. 4 illustrates another detailed example of step S16. In this example, step S16 includes three sub-steps. First, step S162A is performing an HHT on the target IMFs, so as to generate an HHT spectrum. Then, step S162B is generating a marginal spectrum based on the HHT spectrum. The marginal spectrum shows the relationship between frequency and energy accumulated during the vibration duration. In a marginal spectrum, the horizontal axis is frequency, and the vertical axis is the accumulated energy. In practice, the curve in the marginal spectrum may have a flat-top, one peak, or two peaks. The flat-top condition shown in FIG. 5(A) implies the energy distribution in the instantaneous frequency vibrating range is uniform. The single-peak condition shown in FIG. 5(B) implies energy is concentrated at a certain frequency. The frequency corresponding to this peak can be previously known based on the location where energy concentrates in the instantaneous frequency vibrating region in the HHT spectrum. The two-peak condition shown in FIG. 5(C) implies energy is concentrated at a high frequency limit and a low frequency limit. The frequencies corresponding to the two peaks can also be previously known based on the locations where energy concentrates in the instantaneous frequency vibrating region in the HHT spectrum.

Step S162C is judging whether the damage condition exists in the mechanical system based on the marginal spectrum. For instance, cross-referencing the marginal spectrum of the mechanical system under test with a reference marginal spectrum can provide insights into the status of the mechanical system. In practice, the instantaneous frequency vibrating region and the peak locations can first be confirmed before comparing the energy changes in high/low frequencies. The following points can be considered as the basis for judging whether a damage condition exists: (comparing to a normal marginal spectrum) whether the high-frequency energy in the marginal spectrum becomes lower or spreads, the deviation level of the high-frequency peak, whether the low-frequency energy becomes higher or spreads, and whether the main frequency deviates. In practice, marginal spectrums corresponding to normal condition and various damage conditions can be previously generated and stored for future comparison reference. In other words, step S162C can include comparing the marginal spectrum generated in step S162B and at least one reference marginal spectrum, so as to judge whether a damage condition exists in the mechanical system.

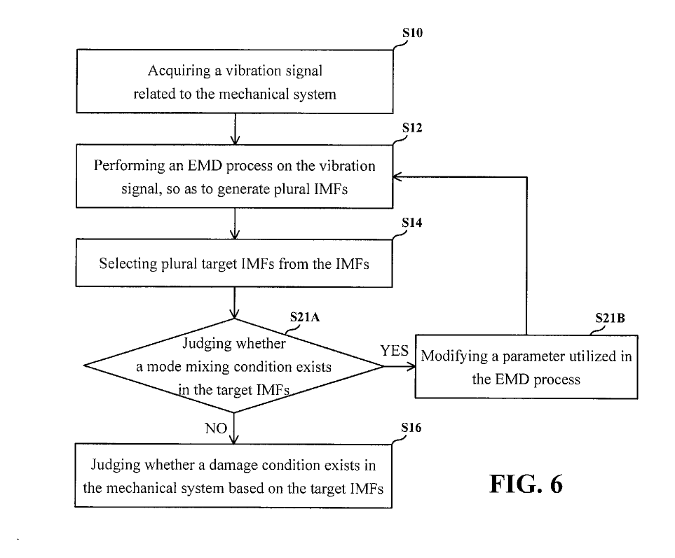

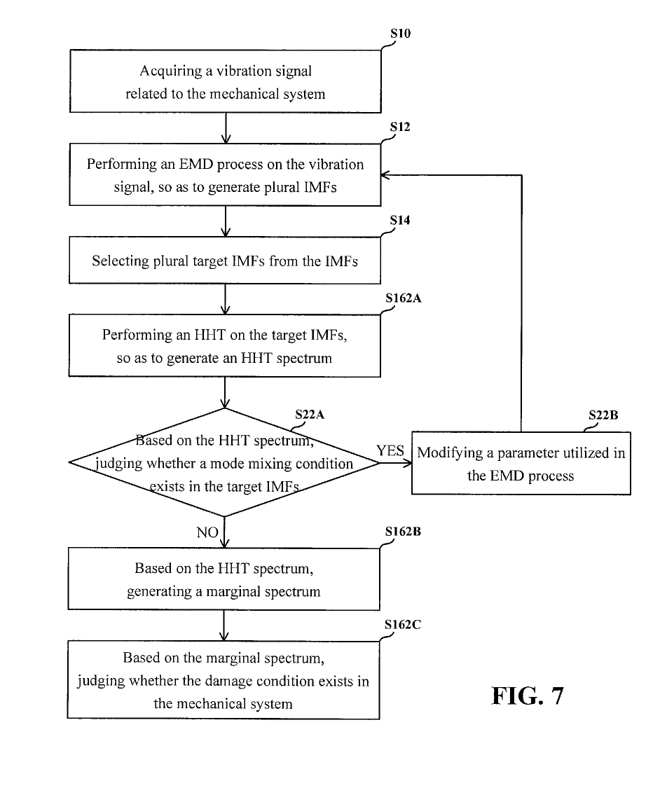

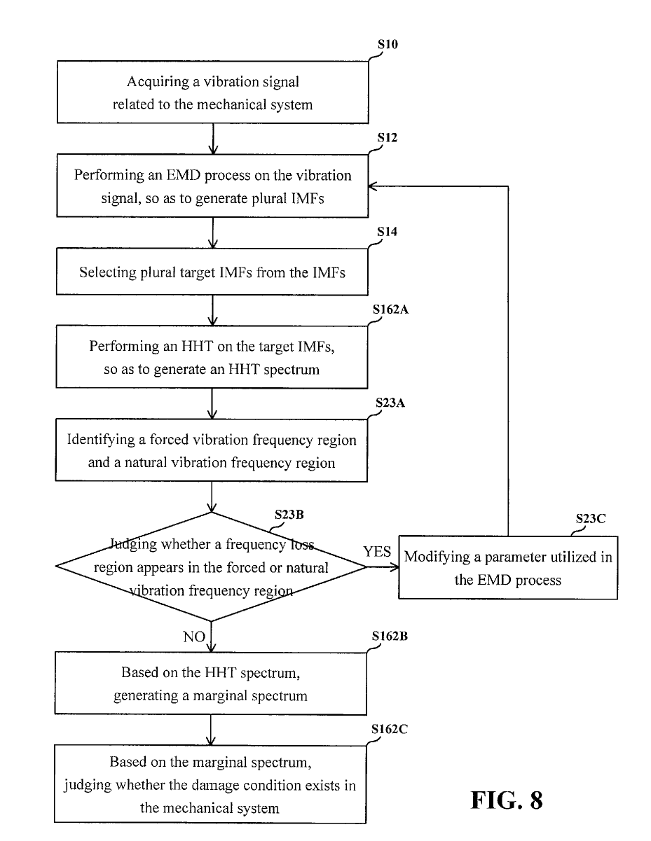

In embodiments according to the invention, several different judgment mechanisms for deciding whether the target IMFs selected in step S14 are ideal enough can be added (but not necessary). If the results of the EMD process are not ideal enough, the parameters (e.g. the limiting value) in the EMD process can be modified and the EMD process is re-performed. Please refer to FIG. 6 through FIG. 8 and the related explanations.

In the embodiment in FIG. 6, steps S21A and S21B are added between steps S14 and S16. Step S21A is judging whether a mode mixing condition exists in the target IMFs. If the judging result is NO, step S16 is then performed. On the contrary, if the judging result is YES, step S21B is performed to modify a parameter utilized in the EMD process. Subsequently, step S12 is re-performed. In practice, the judgment in step S21A can be implemented by an orthogonal matrix operation. The orthogonal matrix is formed by correlation coefficients of the target IMFs. If some values in the orthogonal matrix are too large, it is judged that a mode mixing condition exists. If the range of mode mixing is too large, the judging result of step S21A can also be YES.

In the embodiment shown in FIG. 7, step S22A and step S22B are further included after step S162A in FIG. 4. Step S22A is judging whether a mode mixing condition exists in the target IMFs based on the HHT spectrum. If the judging result is NO, step S162B is performed. On the contrary, if the judging result is YES, step S22B is performed to modify a parameter utilized in the EMD process. Then, step S12 is re-performed.

In the embodiment shown in FIG. 8, step S23A through step S23C are further included after step S162A in FIG. 4. Step S23A is identifying a forced vibration frequency region and a natural vibration frequency region. When there is a damage condition, forced vibrations different from normal vibrations occur. In the forced vibration frequency region, energy is more concentrated and the vibration is more irregular. In the natural vibration frequency region, the vibration is more regular and stable. Then, step S23B is judging whether frequency loss appears in the forced vibration frequency region or the natural vibration frequency region. If frequency loss appears in the forced or the natural vibration frequency regions, the high or low frequency peak value in the marginal spectrum may disappear because of loss of accumulated energy. Frequency loss will lead to incorrect analysis results. Hence, if the judging result of step S23B is YES, step S23C will be performed to modify a parameter utilized in the EMD process. Then the EMD process in step S12 is re-performed.

It should be noted that, in practice, the judgment mechanisms shown in FIG. 6˜FIG. 8 can be selectively or all combined in one process.

In other embodiments according to the invention, step S16 can be implemented in different ways. For example, step S16 can include the following sub-steps: (1) performing a fast Fourier transform on the target IMFs, so as to generate a Fourier spectrum; (2) determining an extreme value of the Fourier spectrum; and (3) based on the extreme value, judging whether the damage condition exists in the mechanical system. In practice, extreme values corresponding to various damage conditions can be previously generated and stored for future comparison reference.

In another embodiment, step S16 can include the following sub-steps: (1) performing an HHT on the target IMFs, so as to generate an HHT spectrum; and (2) based on the HHT spectrum, judging whether the damage condition exists in the mechanical system. In other words, whether a damage condition exists in the mechanical system can also be known by comparing the generated HHT spectrum and a reference spectrum.

Furthermore, in another embodiment, step S16 can include the following sub-steps: (1) determining generalized zero-crossing rates of the target IMFs; and (2) based on the generalized zero-crossing rates, judging whether the damage condition exists in the mechanical system. In other words, various analysis results, not limited to the ones shown in FIG. 2 and FIG. 4, derived based on the target IMFs generated in step S14 can be used as the basis of judgment.

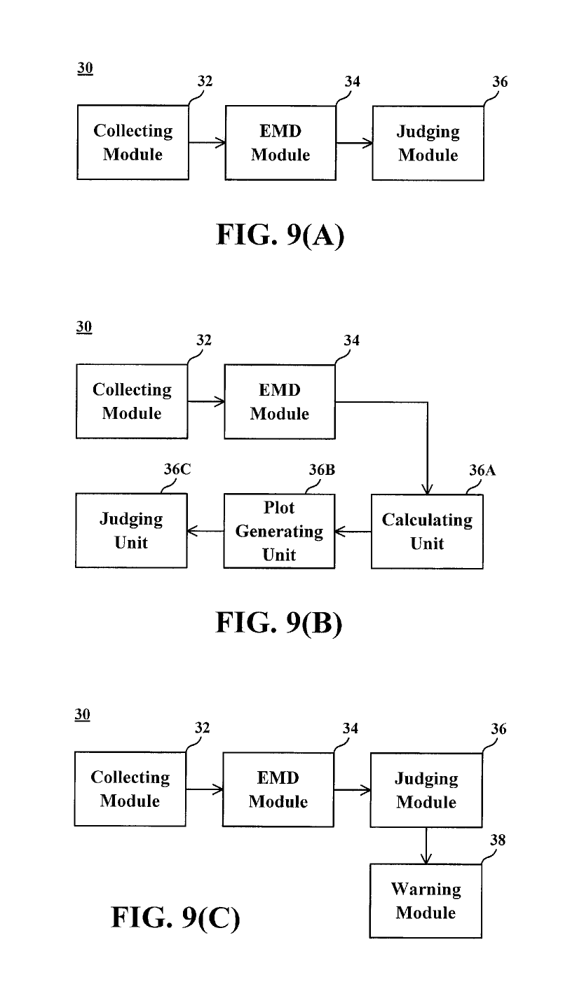

Please refer to FIG. 9(A), which illustrates the block diagram of the apparatus for judging the status of a mechanical system in one embodiment according to the invention. The apparatus 30 includes a collecting module 32, an EMD module 34, and a judging module 36. The collecting module 32 is used for acquiring a vibration signal related to the mechanical system. In the EMD module 34, an EMD process is performed on the vibration signal, so as to generate plural IMFs. EMD module 34 also selects plural target IMFs from the IMFs. The judging module 36 is used for judging whether a damage condition exists in the mechanical system based on the target IMFs.

As shown in FIG. 9(B), the judging module 36 can include a calculating unit 36A, a plot generating unit 36B, and a judging unit 36C. The calculating unit 36A is used for determining zero-crossing rates and an energy distribution of the target IMFs. The plot generating unit 36B is used for generating an order-energy plot based on the zero-crossing rate and the energy distribution. The judging unit 36C is used for judging whether the damage condition exists in the mechanical system based on the order-energy plot. The operation details of the modules have been clearly explained in above embodiments.

In addition, as shown in FIG. 9(C), the apparatus 30 can further include a warning module 38. If the judging module 36 judges that the damage condition exists, the warning module 38 can send out a warning message (e.g. text, sound, or light), so as to inform the manager.

As described above, in the methods and apparatuses according to the invention, IMFs generated by an EMD process are utilized as the basis for judgment. Because the EMD process can be applied to nonlinear or nonstationary signals, the vibration signal of a mechanical system can be better analyzed and reveals the authentic status of a mechanical system. Further, the methods and apparatuses according to this invention can be completely automatized. Experts for interpreting the analysis results are not needed. In addition, the methods and apparatuses according to this invention can judge the level and type of damages in a mechanical system. Accordingly, the maintenance man of the mechanical system can timely replace or repair the damaged device before the mechanical system is seriously damaged. With the methods and apparatuses according to this invention, cost can be saved, product yield can be raised, and the work life of mechanical systems can be prolonged.

With the example and explanations above, the features and spirits of the invention will be hopefully well described. Those skilled in the art will readily observe that numerous modifications and alterations of the device may be made while retaining the teaching of the invention. Accordingly, the above disclosure should be construed as limited only by the metes and bounds of the appended claims.

What is claimed is:

1. A method for judging the status of a mechanical system, comprising:
(a) acquiring a vibration signal related to the mechanical system;
(b) performing an empirical mode decomposition (EMD) process on the vibration signal, so as to generate plural intrinsic mode functions (IMFs);
(c) selecting plural target IMFs from the IMFs; and
(d) based on the target IMFs, judging whether a damage condition exists in the mechanical system.

2. The method of claim 1, wherein in step (b), an intermittency criterion or an ensemble EMD (EEMD) is utilized in the EMD process.

3. The method of claim 1, wherein step (c) comprises:
calculating a zero-crossing rate for each of the IMFs; and
selecting the IMFs with zero-crossing rates corresponding to a target frequency band as the target IMFs.

4. The method of claim 1, between step (c) and step (d), the method further comprising:
judging whether a mode mixing condition exists in the target IMFs; and
if YES, modifying a parameter utilized in the EMD process and re-performing step (b) and step (c).

5. The method of claim 1, wherein step (d) comprises:
(d1) determining zero-crossing rates and an energy distribution of the target IMFs;
(d2) based on the zero-crossing rates and the energy distribution, generating an order-energy plot; and
(d3) based on the order-energy plot, judging whether the damage condition exists in the mechanical system.

6. The method of claim 5, wherein step (d3) comprises:
determining a similarity between the order-energy plot and a reference order-energy plot, wherein the reference order-energy plot is related to the damage condition; and
based on the similarity, judging whether the damage condition exists in the mechanical system.

7. The method of claim 1, wherein step (d) comprises:
determining generalized zero-crossing rates of the target IMFs; and
based on the generalized zero-crossing rates, judging whether the damage condition exists in the mechanical system.

8. The method of claim 1, wherein step (d) comprises:
performing a fast Fourier transform on the target IMFs, so as to generate a Fourier spectrum;
determining an extreme value of the Fourier spectrum; and
based on the extreme value, judging whether the damage condition exists in the mechanical system.

9. The method of claim 1, wherein step (d) comprises:
performing a Hilbert-Huang transform (HHT) on the target IMFs, so as to generate an HHT spectrum; and
based on the HHT spectrum, judging whether the damage condition exists in the mechanical system.

10. The method of claim 1, wherein step (d) comprises:
(d1) performing an HHT on the target IMFs, so as to generate an HHT spectrum;
(d2) based on the HHT spectrum, generating a marginal spectrum; and
(d3) based on the marginal spectrum, judging whether the damage condition exists in the mechanical system.

11. The method of claim 10, between step (d1) and step (d2), the method further comprising:
based on the HHT spectrum, judging whether a mode mixing condition exists in the target IMFs; and
if YES, modifying a parameter utilized in the EMD process and re-performing step (b) and step (c).

12. The method of claim 10, between step (d1) and step (d2), the method further comprising:
identifying a forced vibration frequency region and a natural vibration frequency region;
judging whether a frequency loss region in the HHT spectrum appears in the forced vibration frequency region or the natural vibration frequency region; and
if YES, modifying a parameter utilized in the EMD process and re-performing step (b) and step (c).

13. The method of claim 10, wherein step (d3) comprises:
based on the difference between the marginal spectrum and a reference marginal spectrum, judging whether the damage condition exists in the mechanical system.

14. An apparatus for judging the status of a mechanical system, comprising:
a collecting module for acquiring a vibration signal related to the mechanical system;
an empirical mode decomposition (EMD) module for performing an EMD process on the vibration signal, so as to generate plural intrinsic mode functions (IMFs), and selecting plural target IMFs from the IMFs; and
a judging module for judging whether a damage condition exists in the mechanical system based on the target IMFs.

15. The apparatus of claim 14, wherein the judging module comprises:
a calculating unit for determining zero-crossing rates and an energy distribution of the target IMFs;
a plot generating unit for generating an order-energy plot based on the zero-crossing rate and the energy distribution; and
a judging unit for judging whether the damage condition exists in the mechanical system based on the order-energy plot.

16. The apparatus of claim 15, wherein the judging unit first determines a similarity between the order-energy plot and a reference order-energy plot, and then judges whether the damage condition exists in the mechanical system based on the similarity, wherein the reference order-energy plot is related to the damage condition.

17. The apparatus of claim 14, further comprising:
a warning module, if the judging module judges that the damage condition exists, the warning module sending out a warning message.
